(19) United States
(12) Patent Application Publication
(10) Pub. No.: US 2003/0116649 A1
(43) Pub. Date: Jun. 26, 2003

(54) Apparatus for surface treatment and use of the apparatus

(76) Inventor: Peter Nielsen, Aars (DK)

Correspondence Address: James C Wray, 1493 Chain Bridge Road Suite 300, Mc Lean, VA, 22101, US

(21) Appl. No.: 10/240,843

(22) PCT Filed: Apr. 3, 2001
(86) PCT No.: PCT/DK01/00220

(30) Foreign Application Priority Data
Apr. 5, 2000 (DK) PA 2000-00561

(51) Int. Cl. A62C 5/00; A62C 31/00; B05B 7/04

(52) U.S. Cl. 239/424; 239/398

(57) ABSTRACT

Apparatus for surface treatment, wherein the apparatus has a tool unit movable on a surface. The tool unit comprises a jet tool for directing a jet of solid particles, preferably CO2 particles, towards the surface for removal of a surface layer. The tool unit further comprises an applicator for application of a surface coating on the surface after removal of the surface layer.

The present invention relates to an apparatus for surface treatment according to the preamble of claim 1. The invention further relates to use of such an apparatus.

Before surfaces are painted or otherwise coated, surface pre-treatment including cleaning is usually applied, where old coating or dirt in general may be removed. An example of an apparatus for such cleaning is disclosed in U.S. Pat. No. 5,782,253.

After this pretreatment, it is important that no dust accumulates on the surface, because this would result in a unsatisfactory coating. Therefore, dust-free rooms are established in most professional coating enterprises. Dust free rooms are very expensive to establish and very expensive to keep clean. However, the necessity of a clean environment forces the enterprises to this kind of investment.

Though it is possible to avoid dust accumulating on the surface, the situation is much more complicated when aluminium has to be coated. Aluminium exposed to air tends to oxidise within a very short time, which reduces the sticking capabilities of the subsequently applied coating. Even only a few minutes exposure to air results in an oxide layer with a thickness of several micrometers. Therefore, in order to prevent alumininum objects from oxidation, oxygen free environments have to be used, which involves high costs for an enterprise working with proper aluminium surface coating.

It is the object of the invention to provide an apparatus for surface treatment solving the above mentioned problems in an easy way.

This object is achieved with an apparatus mentioned by way of introduction and characterised as described in the characterising part of claim 1.

The invention has foreseen a tool unit that comprises tools of different kinds such that a surface can be pre-treated, for example cleaned, and coated almost instantaneously. A tool unit of this kind prevents dust accumulation from the environment on the surface of the object, for example polymer, glass or metal, to be coated and prevents oxidisation in particular of aluminium objects before coating.

Cleaning of the surface is accomplished by directing a jet of solid particles towards said surface for removal of a surface layer from said surface. This kind of cleaning is well known, and a variety of particles are available, for example granules, glass beads, slag, sand, carbon dioxide (CO2) pellets and CO2 spray. Before coating, the particles have to be removed from the surface, which is due to standard techniques, for example as described for granules, glass beads and sand in international patent application WO99/37443. However, preferred are CO2 particles, because these simply evaporate without leaving any remnants after hitting the surface.

After pre-treatment of the surface with these particles, a surface coating, for example paint or glue, is applied to the surface of the object from the applicator in the tool unit. When moving the tool unit along the surface of the object, or alternatively moving the object past the tool unit, the surface of the object is cleaned and coated in one cycle of operation.

According to one embodiment of the invention, the jet of particles is a spray of frozen CO2. Such kind of spray is easily achievable with a jet nozzle through which highly pressurised CO2 is pressed. The expansion of the CO2 upon leaving the jet nozzle causes a temperature drop such that the CO2 freezes to miniature solid particles.

Especially, good pre-treatment results may be achieved with a gas nozzle surrounding the jet nozzle, where gas from the gas nozzle at supersonic velocity accelerates the CO2 particles and forms the spray into a narrow and efficient beam. Such an arrangement is described in international patent application WO00/74897.

In order to prevent the pre-treated surface to be cooled so much below ambient temperature that water may condense on the surface, the surface after pre-treatment with CO2 may be heated with a heater, which is installed in the tool unit.

In another embodiment of the invention, the velocity between the surface of the object to be treated and the tool unit during mutual displacement in a direction parallel with the surface of the object is measured with a velocity sensor. This velocity may be used to control the amount of applied coating. Therefore, the apparatus also comprises a coating control unit for application of a predetermined amount of coating to the surface in dependence of the velocity. This feature ensures that the right amount of coating is applied independent of the treatment velocity.

In a further embodiment of the invention, the apparatus comprises a temperature sensor for determination of the temperature of the surface. The surface may be heated by the heater to a temperature which is optimal for the coating. The heater may functionally be linked to the temperature sensor in order to ensure optimal temperature conditions.

Such a temperature sensor may be an infrared radiation sensor. Infrared radiation characteristic of the temperature of the surface may be sensed and evaluated. The data representative for the surface temperature may easily be discriminated from the radiation which may occur due to the heater.

In a still further embodiment of the invention, the apparatus further comprises a surface roughness sensor for determination of the roughness of the surface. Sensors of this kind are described in U.S. Pat. Nos. 5,179,425 and 5,757,496.

In an even further embodiment of the invention, the apparatus comprises a humidity sensor for determination of the humidity in the volume near the surface. Registering the humidity around the surface of the object can be used to optimise the heat treatment of the surface in order to achieve an optimal coating.

The signals from the sensors may be monitored and used for quality control. In this case, for each object and each treatment, data may be collected in a manual, which is a great help when a surface treatment turns out not to be in accordance with the desired quality.

Useful for the quality control is also an imaging of the surface before and after treatment of the surface. Therefore, the tool unit comprises a camera for imaging of said surface.

The invention will be explained in more detail in the following with reference to the drawings, where

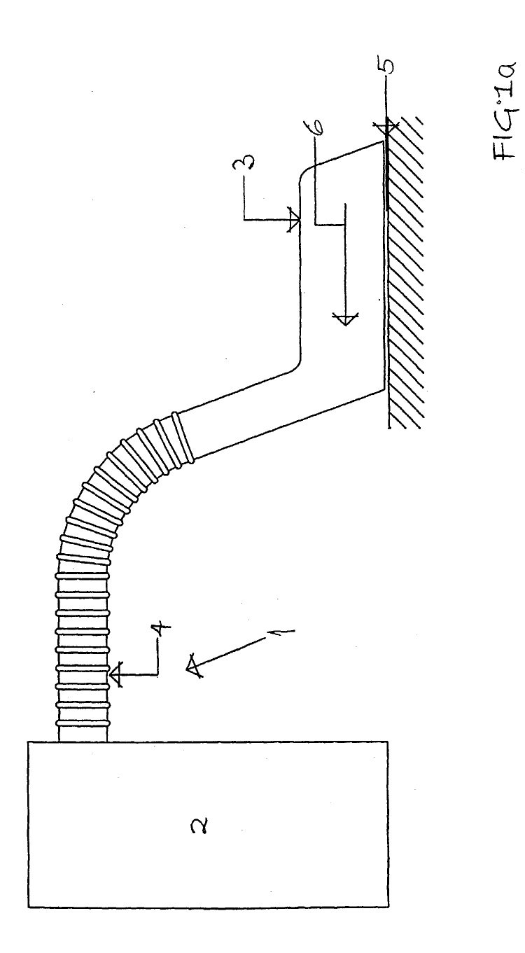

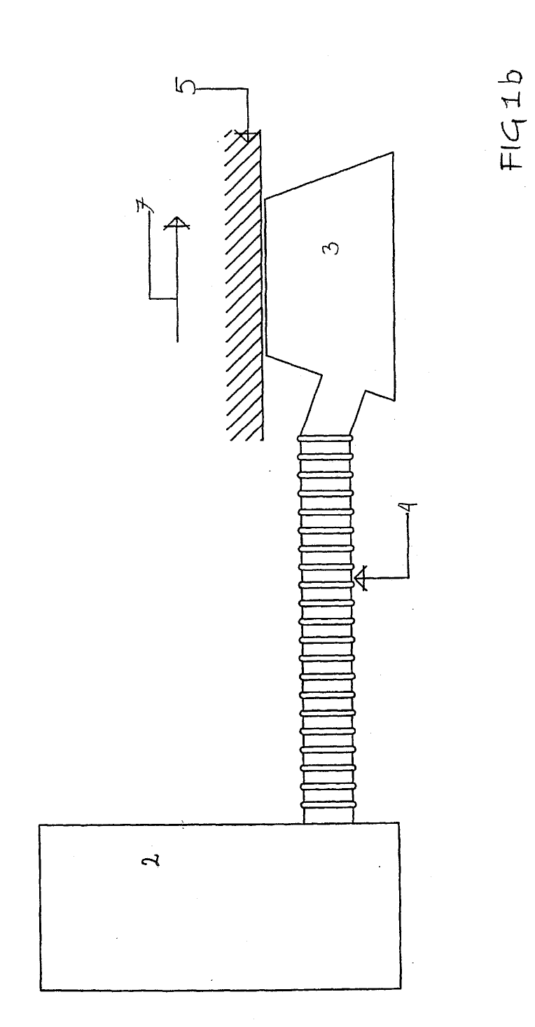

FIG. 1 illustrates an apparatus according to the invention,

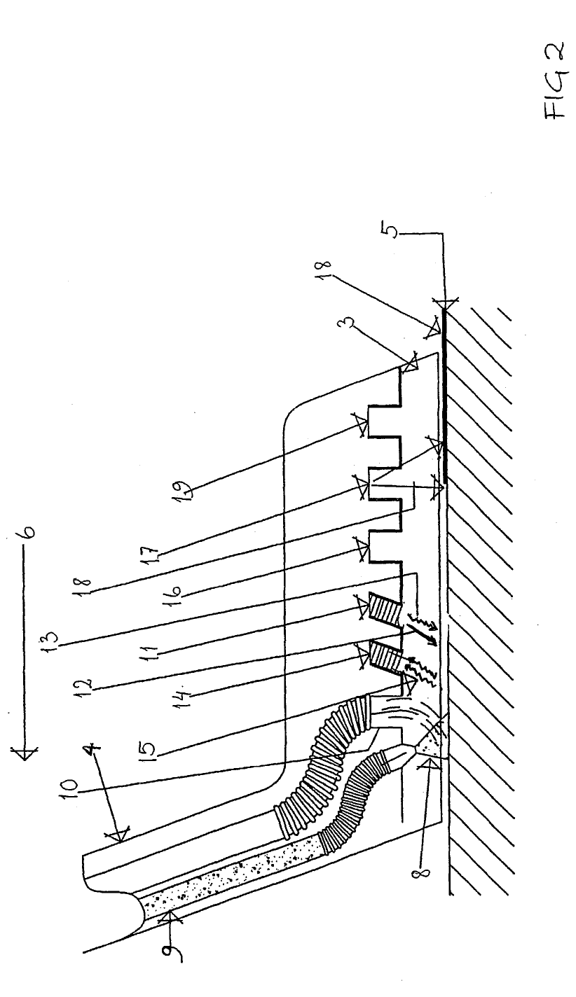

FIG. 2 illustrates the tool unit in more detail,

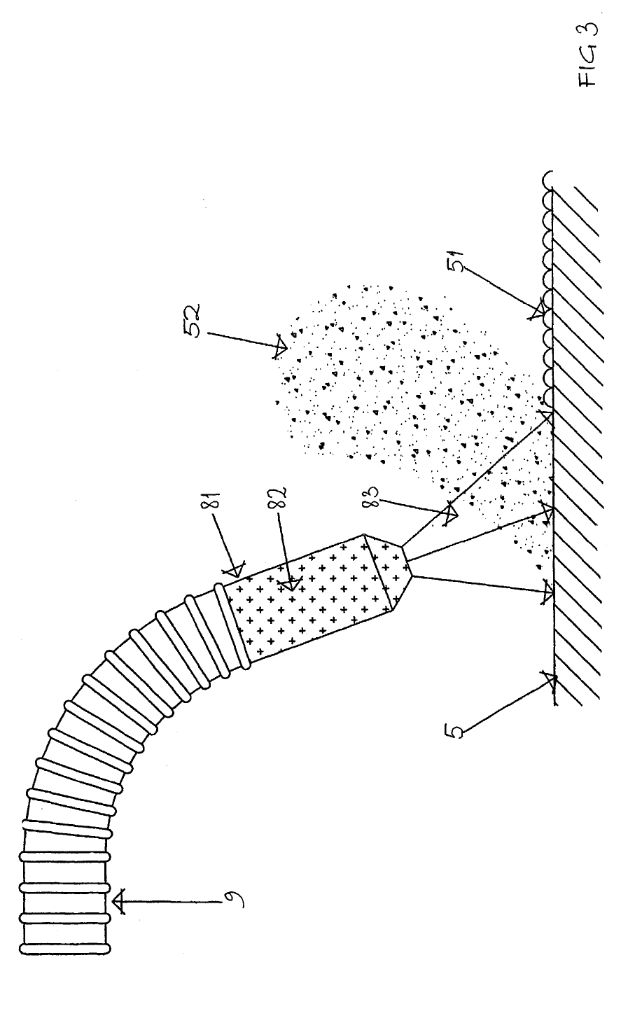

FIG. 3 shows the jet nozzle,

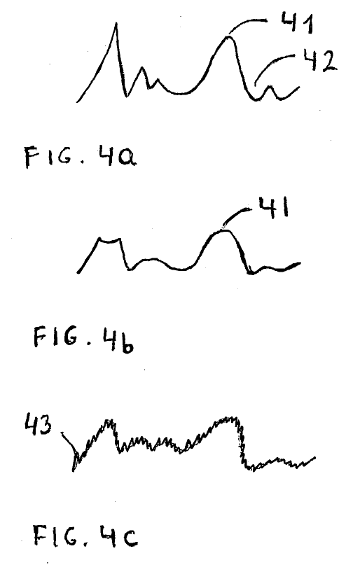

FIG. 4 illustrates the surface structure prior to and after pre-treatment.

FIG. 1 illustrates an apparatus 1 according to the invention. The apparatus 1 comprises a supplier station 2 for supplying the tool unit 3 through a coupling tube 4 with the necessary substances and other supplies, for example electricity, for the treatment of the surface 5 of an object. The coupling tube 4 also serves for any other transfer, for example data transfer, between the supplier station 2 and the tool unit 3.

The tool unit is constructed to function during movement of the tool unit along a surface 5 in a certain direction, as indicated by an arrow 6 in FIG. 1a. The surface 5 is shown as a plane surface, but may also bend or have other forms. The tool unit 3 may be designed correspondingly to fit optimally to the surface 5.

It may be an advantage not to move the tool unit 3, but instead to move the object to be surface treated. In this case, the object with the surface 5 is moved across the tool unit 3 as indicated with an arrow 7 in FIG. 1b.

The tool unit 3 is shown in greater detail in FIG. 2. For pre-treatment, the surface 5 is exposed to a jet 8 of solid particles. The particles, for example granules, glass beads, slag, sand, CO2 pellets, or CO2 spray, are supplied from the supplier station 2 and enter the tool unit 3 through an particle supplier tube 9 inside the coupling tube 4. Particles hit the surface 5 of the object and remove a surface layer the thickness of which depends on the physical properties of the surface 5, the particles used and the pre-chosen parameters as velocity and amount of the particles.

In order to remove the solid particles, a suction device 10 is comprised by the tool unit. An efficient removal of the particles can be achieved by well-known techniques leaving a clean surface 5 after pre-treatment. If necessary, the tool unit may comprise a blowing unit (not shown), which blows gas on the surface 5 to aid the removal of particles from the surface 5.

Preferably, frozen CO2, is used as solid particles, preferably in the form of a spray. This kind of treatment has a number of advantages. These particles evaporate without leaving any remnants which facilitates cleaning of the surface 5. Furthermore, the rapid cooling of the surface 5 due to the low temperature of the particles induces stress in the surface layer, which results in a efficient removal of the surface layer, especially if the expansion coefficient of the surface layer, for example paint or glue, is different than the expansion coefficient of the underlying solid.

With reference to FIG. 3, the CO2 particle production in the preferred embodiment is explained in more detail. The tool unit 3 is equipped with a jet nozzle 81, which is supplied with liquid CO2 or with gaseous CO2 under high pressure, 82, from a CO2 supplier tube 9 connected to the supplier station 2 having a storage tank of CO2. When CO2 is pressed through the jet nozzle 81, the CO2 expands rapidly with a drastic decrease of temperature in the CO2. This causes the CO2 to freeze into small solid particles. Due to the expansion of the CO2, this particle spray 83 attains a high velocity towards the surface 5. Thereby, the surface layer 51 will be removed in small pieces 52, that are accelerated away from the surface 5 and can be removed by a suction device as explained in connection with FIG. 2. As the main temperature decrease of the CO2 during expansion occurs at a certain distance from the jet nozzle 81, the jet nozzle 81 will not be cooled sufficiently for the CO2 to freeze inside the jet nozzle 81, which is a great advantage securing free passage of CO2 through the jet nozzle 81. However, even in the case, that expanding CO2 may cool the jet nozzle 81 substantially, the nozzle 81 may easily be provided with a heating mechanism securing a proper function of the jet nozzle 81.

The jet nozzle 81 may be surrounded by a gas nozzle for supply of a supersonic stream of gas for forming and acceleration of said CO2 spray jet 8 towards the surface 5.

The removal of the surface layer is generally fast with this method, which results in only a slight cooling of the remaining surface of the solid after pre-treatment. Especially, if the solid is aluminium, the temperature will very quickly increase to the original temperature of the solid because of heat dissipation in the solid. Experiments have shown that the pre-treatment of an aluminium surface only reduced the surface temperature by 1.5° from ambient temperature.

Even in the case of the solid being a bad heat conductor or having low heat capacity, the surface may be heated to ambient temperature by a heater 11 comprised by the tool unit 3, which is illustrated in FIG. 2. This heating ensures, that no water condenses on the surface after pre-treatment, which is important for a thorough coating.

The heater 11 may be a supplier of heated gas, indicated by an arrow 12, or a supplier of heating radiation, as indicated by a wiggled arrow 13.

Whether heat is necessary for the surface 5 to attain ambient temperature, may be determined by a temperature sensor 14. With respect to the moving direction 6 of the tool unit 3, the temperature sensor 14 may be placed in front of the heater 11, as shown in FIG. 2, or after the heater 11. Alternatively, one temperature sensor 14 may be arranged in front of the heater 11 and another temperature sensor 14 may be placed after the heater 11. In this case, full control of the temperature is achieved. The temperature sensor 14 may be a sensor for infrared radiation 15 which is emitted from the surface 5.

The temperature to be attained may be ambient temperature as mentioned previously, but it may also be a lower temperature or a higher temperature depending on the treatment after pretreatment. For certain coatings, an elevated temperature may be an advantage.

After pre-treatment of the surface, the surface receives a coating 18 from the applicator 17 in the tool unit 3. The coating is applied according to predetermined criteria and may cover the surface 5 completely or in part.

In order to achieve an optimum surface before and after coating, a surface roughness sensor 16 may be comprised by the tool unit 3. Eventually two of theses sensors may be applied, one before the coating applicator 17 and one after the applicator 17. Principles of surface roughness sensors are, for example, disclosed in U.S. Pat. No. 5,179,425 and in European patent application EP 863 380.

After application, the coating 18 may be post-treated by a post-treatment unit 19. Such post-treatment may include drying, heat treatment, or irradiation with ultra violet light or X-rays.

In order to obtain a thorough coating, the velocity between the tool unit 3 and the surface 5 may be monitored by a velocity sensor. In a simple version, the velocity sensor comprises a wheel which rolls on the treated surface. An appropriate transducer transforms the information to an electronically readable signal, which can be evaluated and be linked to the coating application.

For each object that is treated by the apparatus 1 according to the invention, signals of the sensors may be registered and stored for later evaluation. This data storage may be accomplished in a computer which, for example, is located in the tool unit 3 or, more preferably, in the supplier station 2. Thus, when an object has been surface treated, an object identification, for example readable as a bar code on the object, may be linked to a plurality of parameters and sensor data. This way, the procedure used for surface treatment of a certain object can at any later time be studied for evaluation and optimisation and as a control in case of complaints from customers. A bar code reader may be installed separately or in the tool unit.

The coupling tube 4 between the supplier station 2 and the tool unit 3, may be constructed such that different tool units 3 may be coupled to the supplier station 2. Depending on the object and the surface treatment, tool units of different kind may be connected. The tool unit 3 for paint removal and subsequent paint application may be different from another tool unit, which is used to remove the aluminium oxide layer from an aluminium surface and to apply glue on the object for further processing.

In the case of surface treatment of aluminium, the apparatus according to the invention has a number of advantages. Surface pre-treatment and application of a coating, for example glue, is fast and therefore prevents a substantial oxidation of the surface prior to gluing, resulting in a better sticking of the coating.

When glue is applied to objects, it is important, that the amount of glue that is applied is precise. Too small an amount of glue results in a non-optimal product with reduced strength. On the other hand, if too much glue is applied, glue may be pressed out from the gap between the object, when these are pressed together. This extra glue is wasted, which implies higher costs and is environmentally disadvantageous, and the glue needs to be removed for a proper appearance of the product, which implies additional labour and eventually additional use of glue removing chemicals. The velocity data in an apparatus according to the invention can be used to control the application of the glue such that an optimal gluing can be achieved.

A preference to use CO2 spray instead of other solid particles is due to the fact that experiments have shown that application of CO2 spray results in better sticking capabilities than if another pre-treatment, for example with glass beads or CO2 pellets is used. The better sticking capabilities of the coating, in turn, results in a higher strength between objects when glued together. The answer to this is to be found in the following explanation with reference to FIG. 4. FIG. 4a is a sketch of the topology of an aluminium surface before pre-treatment, where the surface has a certain macro-roughness with peaks 41 and trenches 42. After exposure to CO2 pellets or glass beads, the surface may appear as indicated in FIG. 4b. The total surface area, though still rough on the macroscopic scale has, in fact, been reduced, as peaks 41 have been reduces in height and appear not so sharp any more. In contrast, if the surface is treated with CO2 spray, the surface roughness is reduced on a macroscopic scale as in the case above, but increased on a microscopic scale due to an achieved micro-roughness 43. The total surface area is therefore increased, which is believed to be the reason for better sticking capabilities on surfaces treated by CO2 spray.

In order to produce such a CO2 spray, the jet nozzle 81 may be attached to a tube from the CO2 container, which may be a commercially available CO2 container of standard dimensions, without any reduction valve. Thus, no stopping of the CO2 flow due to substantial pressure changes before the jet nozzle 81 may occur. Furthermore, this system is very simple and cheap to produce and maintain. The opening of such a jet nozzle 81 is preferentially 2 mm, but may attain other smaller or larger sizes. For such a jet nozzle 81, CO2 solid particles will form at a distance of about 40 from the nozzle exit.

The tool unit 3 may be modified to comprise an additional heater that heats the surface 5 before the surface 5 is exposed to CO2 particles, which enhances the induced stress in the surface layer due to the larger temperature difference between the heated surface layer and the CO2 particles. The enhanced induced stress generally facilitates the removal of the surface layer as explained in U.S. Pat. No. 5,782,253.

A tool unit 3 according to the invention may be operated manually or operated by a robot in industrial applications. Furthermore, the tool unit 3 may be equipped with wheels and corresponding drivers such that the tool unit 3 may move on the surface 5 in a pre-programmed fashion.

A tool unit 3 according to the invention may easily be modified to apply sticking tape to the surface 5 of the object instead of a coating or in addition to a coating.

Useful for the quality control is also an imaging of the surface 5 before and after treatment of the surface. Therefore, the tool unit 3 may comprise a camera for imaging of the surface before and/or after pre-treatment and coating. Images may be stored for later evaluation and be used for on-line evaluation, for example by computer image analysis. In case, the pre-treatment or coating does not fulfil the requirements, an online evaluation program may change the parameters during the surface treatment in accordance with some specific algorithms.

1. Apparatus for surface treatment, wherein said apparatus has a tool unit, said tool unit and said surface being mutually displaceable in a direction parallel with said surface, wherein said tool unit comprises a jet tool for directing a jet of solid particles towards said surface for removal of a surface layer from said surface, characterised in that said tool unit further comprises an applicator for application of a surface coating on said surface after removal of said surface layer.

2. Apparatus according to claim 1, characterised in that said solid particles are at least one from the group consisting of granules, glass beads, slag, sand, CO2 pellets and CO2 spray.

3. Apparatus according to claim 2, characterised in that that solid particles are CO2 spray and that said jet tool comprises a jet nozzle for production of CO2 spray by expansion of CO2 after spraying from said nozzle.

4. Apparatus according to claim 3, characterised in that said jet tool further comprises a gas nozzle surrounding said jet nozzle for supply of a supersonic stream of gas for forming and acceleration of said CO2 spray jet.

5. Apparatus according to any single one of the previous claims, characterised in that said apparatus further comprises a heater for heating of said surface.

6. Apparatus according to any single one of the previous claims, characterised in that said apparatus further comprises at least one from the group of sensors consisting of
a velocity sensor for determination of the velocity between said surface and said tool unit during mutual displacement in said direction parallel with said surface,
a temperature sensor for determination of the temperature of said surface,
a surface roughness sensor for determination of the roughness of said surface,
a humidity sensor for determination of the humidity in the volume near the surface.

7. Apparatus according to claim 6, characterised in that said apparatus comprises a monitoring system for monitoring of signals from said at least one from said group of sensors.

8. Apparatus according to claim 6 or 7, characterised in that said apparatus comprises a velocity sensor functionally linked to a coating control unit for application of a predetermined amount of coating in dependence of said velocity.

9. Apparatus according to any single one of the previous claims characterised in that said tool unit comprises a camera for imaging of said surface.

10. Use of an apparatus according to any single on of the previous claims for application of glue on a surface of aluminium, polymer or metal.
